(19) United States
(12) Patent Application Publication
(10) Pub. No.: US 2010/0110190 A1
(43) Pub. Date: May 6, 2010

(54) IMAGE PROCESSING APPARATUS

(75) Inventor: Nam Jung Her, Gyeongsangnam-do (KR)

Correspondence Address: RABIN & Berdo, PC, 1101 14TH STREET, NW, SUITE 500, WASHINGTON, DC, 20005, US

(73) Assignee: SAMJUNG CO., LTD, Gyeongsangnam-do (KR)

(21) Appl. No.: 12/595,192

(22) PCT Filed: Apr. 8, 2008
(86) PCT No.: PCT/KR2008/001970

§ 371 Date: Oct. 8, 2009

(30) Foreign Application Priority Data
Apr. 9, 2007 (KR) 10-2007-0034811

(51) Int. Cl. H04N 7/18

(52) U.S. Cl. 348/148; 348/E07.085

(57) ABSTRACT

The present invention is directed to an image processing apparatus and method which is capable of safely processing and storing image data detected by a camera in a car accident. The image processing apparatus has an advantage of more safely preserving the image data, which are detected in occurrence of external impact, even when the black box device is broken due to an external impact, by promptly storing the image data in the nonvolatile and highly impact-resistant detachable memory card. In addition, the image processing apparatus of the present invention has an advantage of effectively preserving emergency-related data even with less power, by supplying power to only devices required to preserve the image data at an emergency. Furthermore, the image processing apparatus of the present invention has an advantage of preventing wasteful power consumption, by setting the apparatus to be operable corresponding to surroundings of the vehicle and extracting only image data for unusual situations.

### TECHNICAL FIELD

The present invention relates to an image processing apparatus and method, and more particularly, to an image processing apparatus and method which is capable of safely processing and storing image data detected by a camera in a car accident.

### BACKGROUND ART

With rapid increase of vehicles, traffic accidents are constantly increasing and accordingly there is an increasing need to clarify who is responsible for traffic accident. In most cases, the parties to a traffic accident are competing in their claims, and accordingly it is the actual circumstances that percentages of faults between the parties are determined based on positions of the parties' cars in the scene of the accident. However, since such an approach is based on clues for clarifying responsibility for the accident after the accident occurs, in most cases, responsibility for the accident is inevitably investigated based on speculation, which may result in disadvantage of one of the parties.

To solve this problem, there appears a method in which a central control center receives and retains correct accident information recorded in a CCTV (Closed-Circuit Television) installed in every road section. However, in most cases, the CCTV is of a fixed type and thus can detect only an accident occurring at a section in which the CCTV is installed, and additionally it has a problem of low resolution and hence difficulty in grasping the correct situation of an accident.

In recent years, there have appeared black box devices that capture correct accident situations and store image signals from cameras of DVRs (Digital Video recorders) installed within vehicles and data detected by various sensors at individuals' demand for managing accident situations.

FIG. 1 is a view showing cameras and sensors connected to a conventional vehicle black box device. Referring to FIG. 1, a plurality of cameras 11 and 12 provided to monitor external and internal situations of a vehicle detect an external object approaching the vehicle and transfer image data of the detected object to a black box device. Accordingly, it is possible to visually show an accident situation by reading and reproducing the image data, which include information on proximate situation of the external object, from the black box device. In addition, a plurality of sensors 21 and 22 is installed in edges of front and rear bumpers of the vehicle for detecting a degree of proximity of the external object, external impacts, etc., information on which is stored in the black box device for grasping a correct accident situation.

FIG. 2 is a view showing a configuration of the conventional vehicle black box device. Referring to FIG. 2, the conventional vehicle black box device includes an image processor 20 for processing image data detected by a camera 30, a sensor 40 for detecting ambient surroundings, a mass data storage 60 for storing the image data of the camera 30 and detection information of the sensor 40, an interface 50 for receiving inputs from a user, and a controller 70 for controlling the above components connected thereto.

In operation, if there occurs an external impact or an internal emergency, the image data obtained through the image processor 20 based on the detection information of the sensor 40 are stored in the mass data storage 60 under control of the controller 80. Additionally, if a user is aware of an emergency, he/she can manipulate the black box device to store the image data and the detection information manually through the interface 50.

In this manner, the black box device can not only show the accident situations visually but also store the detection information on the accident situations to acquire accident position-related and vehicle-related information on the accident spot.

However, the vehicle black box device has a limitation to defense against an external impact, and thus the acquired information may be lost due to damage of the mass data storage by the external impact. In addition, it may be difficult to acquire the vehicle-related information on the accident spot due to power interruption by the external impact. Furthermore, the black box device has to continuously repeat read/write of data from/in the mass data storage 60 against a possible accident, which may result in wasteful power consumption and shortening of life time of the mass data storage 60.

### DISCLOSURE OF INVENTION

### Technical Problem

It is therefore an object of the present invention to provide an image processing apparatus and method which is capable of safely preserving image data and vehicle-related information before and after an accident even under an external impact.

It is another object of the present invention to provide an image processing apparatus and method which is capable of preventing image data from being lost even when power is interrupted due to an external impact, and safely preserving vehicle-related information on the accident spot.

It is still another object of the present invention to provide an image processing apparatus and method which is capable of preventing a wasteful recording operation of a mass data storage storing image data, thereby reducing power consumption and lengthening life time of the mass data storage.

### Technical Solution

To achieve the above objects, according to an aspect, the present invention provides an image processing apparatus including: an image processing unit that processes image data detected by one or more cameras installed in a vehicle; a sensing unit that includes one or more sensors for detecting surroundings of the vehicle; a power source unit that receives power from the vehicle and supplies the power to other components of the vehicle; a virtual memory unit that temporarily stores the image data; a storing unit that stores the image data; a detachable memory unit that backs up the image data at emergency; and a controller that stores the image data from the image processing unit in the storing unit in stop or normal driving of the vehicle based on detection information from the sensing unit, and stores the image data of the virtual memory unit in the detachable memory unit at the emergency. The controller interrupts supply of power to various components at the emergency, except the virtual memory unit, the detachable memory unit and the controller itself, based on the detection information from the sensing unit.

According to another aspect, the present invention provides an image processing method of collecting image data through one or more cameras installed in a vehicle and storing the collected image data in a plurality of storing means based on environments of the vehicle, the method including: a first step of storing the image data in first storing means if the vehicle remains stopped; a second step of storing the image data in the first storing means and second storing means when the vehicle is moved; and a third step of transferring the image data stored in the first storing means to third detachable storing means at an emergency.

Preferably, the detachable memory unit is a detachable memory card. Since the memory card is nonvolatile, small-sized, and highly impact-resistant, it is possible to safely preserve the image data against an external impact.

Accordingly, if there occur emergency situations such as proximity of an external object to the vehicle and collision of the vehicle with an external object, in order to safely preserve image data related to the emergency situations, by transferring the image data stored in the virtual memory unit to the detachable memory unit, it is possible to prevent the image data from being lost even if the black box device is broken due to an external impact.

### ADVANTAGEOUS EFFECTS

The image processing apparatus of the present invention has an advantage of more safely preserving the image data, which are detected in occurrence of external impact, even when the black box device is broken due to an external impact, by promptly storing the image data in the nonvolatile and highly impact-resistant detachable memory card.

In addition, the image processing apparatus of the present invention has an advantage of effectively preserving emergency-related data even with less power, by supplying power to only devices required to preserve the image data at an emergency.

Furthermore, the image processing apparatus of the present invention has an advantage of preventing wasteful power consumption, by setting the apparatus to be operable corresponding to surroundings of the vehicle and extracting only image data for unusual situations.

### BRIEF DESCRIPTION OF THE DRAWINGS

FIG. 1 is a view showing cameras and sensors connected to a conventional vehicle black box device.

FIG. 2 is a view showing a configuration of the conventional vehicle black box device.

FIG. 3 is a view showing a state where a vehicle black box device according to an embodiment of the invention is installed in a vehicle.

FIG. 4 is a view showing a detailed configuration of the vehicle black box device according to the embodiment of the invention.

FIG. 5 is a view showing a detailed configuration of a power source unit according to an embodiment of the invention.

FIG. 6 is a flow chart illustrating a process of preserving image data according to an embodiment of the invention.

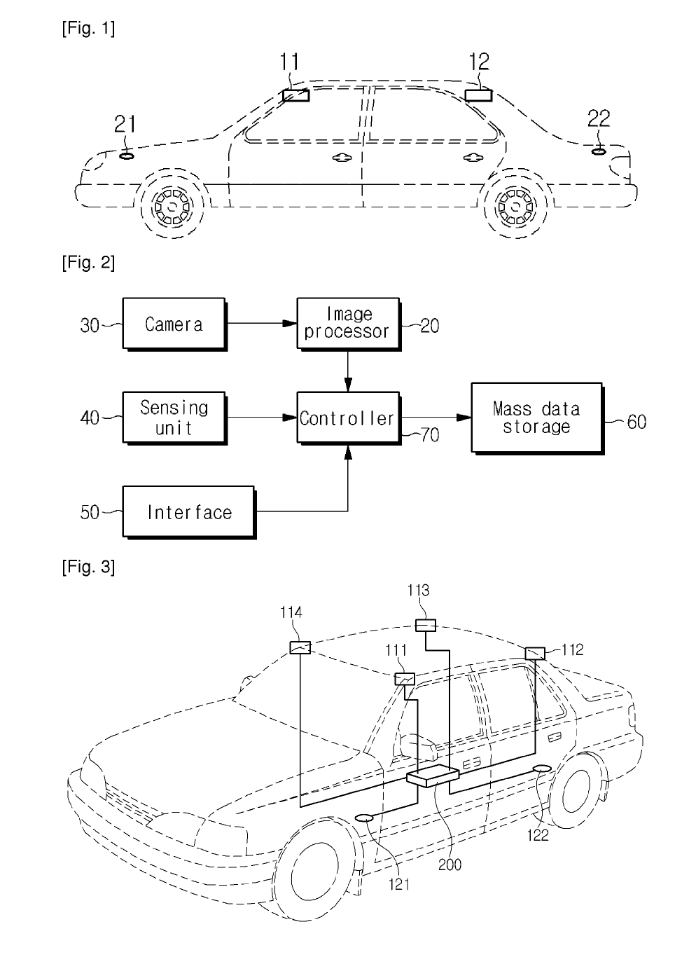

### BEST MODE FOR CARRYING OUT THE INVENTION

Hereinafter, an image processing apparatus of the present invention will be described in detail with reference to the accompanying drawings.

FIG. 3 is a view showing a state where a vehicle black box device corresponding to an image processing apparatus according to an embodiment of the invention is installed in a vehicle. Referring to FIG. 3, a black box device 200 stores image data detected by one or more cameras 111, 112, 113 and 114 provided in the internal or external of a vehicle. The cameras 111, 112, 113 and 114 are preferably installed in the top side of the vehicle in order to cover a long range in all directions. The cameras 111, 112, 113 and 114 can immediately cope with proximity of an external object based on detection information of sensors 121 and 122 to detect the surroundings of the vehicle and motion of an image.

The sensors 121 and 122 may be installed in the internal or external of the vehicle to detect the surroundings of the vehicle. For example, the sensors 121 and 122 may be installed in the external of the vehicle to detect proximity of an external object, collision with an external object, etc., and may be installed in the internal of the vehicle to detect intrusion of an unauthorized person in the vehicle, breaking out of fire, etc. In addition, the sensors 121 and 122 may be connected to various internal devices of the vehicle to check movement, speed, remaining amount of fuel, etc. of the vehicle. Furthermore, a power detecting sensor may be installed in the internal of the black box device 200 to detect interruption of power supply due to an external impact and cause the black box device 200 to operate according to the detection of interruption.

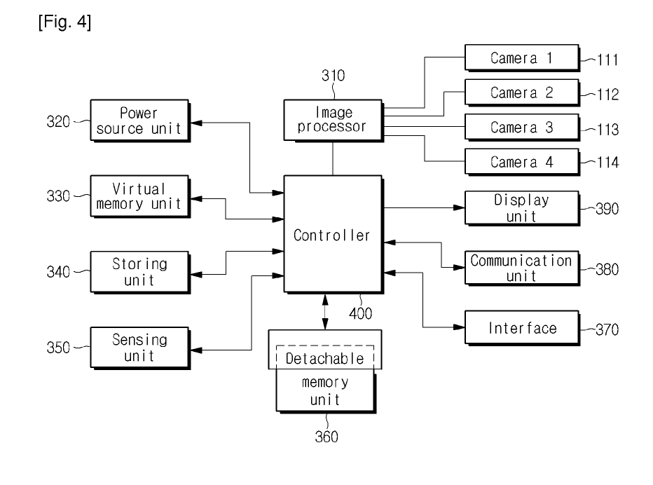

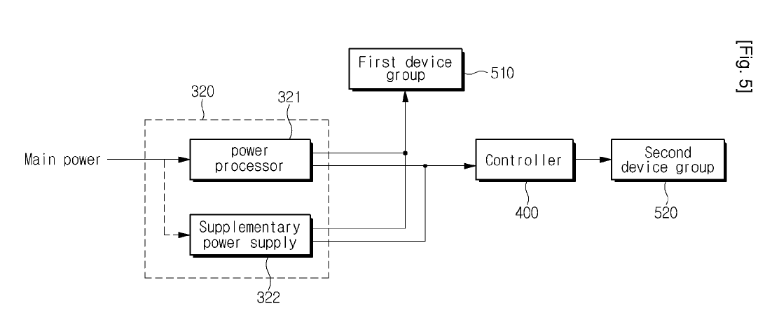

FIG. 4 is a view showing a detailed configuration of the vehicle black box device.

Referring to FIG. 4, the image signal detected by one or more cameras 111, 112, 113 and 114 installed in the internal or external of the vehicle is processed into digital information by an image processor 310, and such digital image data is managed by a controller 400 that controls the overall operation of the black box device.

In addition, if it is determined based on detection information of a sensing unit 350 including sensors (see FIG. 3) that the vehicle has no movement, the controller 400 is set to a normal mode and temporarily stores the image data in a virtual memory unit 330. Since there is little risk of an accident if the vehicle has no movement, only the virtual memory 330 including a volatile memory is used to periodically update the image data. The volatile memory is preferably a RAM (Random Access Memory) to temporarily store the image data.

If it is determined based on the detection information of the sensing unit 350 that, during operation in the normal mode, there occurs unusual situations such as a theft case, fire or the like in stop of the vehicle, or the vehicle is moved, the controller 400 is switched from the normal mode to an operation mode and stores image data related to such situations.

In more detail, the controller 400 detects intrusion into the vehicle, fire, etc. based on the detection information of the sensing unit 350 including temperature, infrared or ultrasonic sensors, is switched from the normal mode to the operation mode, and stores the image data in a storage 340.

In addition, based on the detection information of the sensing unit 350 including one or more sensors installed in an engine, a fuel injector, etc. of the vehicle, the controller 400 determines whether or not the vehicle is driven, and if it is determined that the vehicle is driven, the controller 400 is switched from the normal mode to the operation mode and stores the image data in the storage 340.

As described above, since the storage 340 is required to record unusual situations or driving situations in real time, it is preferably a hard disk as a mass storing device or a nonvolatile memory.

If a danger by proximity of an external object or collision with an external object in driving or stop of the vehicle is detected based on the detection information of the sensing unit 350, the controller 400 is switched from the operation mode to an emergency mode and can safely preserve the image data by transferring the image data from the virtual memory 330 to a detachable memory unit 360 for backup of the image data. In addition, if power interruption of a power source unit 320 for supplying power to various components of the vehicle, which may occur due to external impact on the vehicle, is detected based on the detection information of the sensing unit 350, a supplementary power supply of the power source unit 320 is actuated in order that an operation corresponding to the emergency mode is not stopped.

In addition, the detachable memory 360 includes one or more detachable memory cards in which the above-mentioned information is stored, and preferably further includes a detachable memory interface to connect the memory card(s) to the controller 400. Example of the memory cards may include at least one of various kinds of small detachable nonvolatile memory devices including a CF (Compact Flash) card, an MD (Micro Drive) card, a SM (Smart Media) card, a SD (Secure Digital) card, an MM (Multi Media) card, an USB MS (Memory Stick), etc.

The detection information of the sensing unit 350, on the basis of which the mode of the controller 400 is changed, may be collected by the controller 400 and stored in the storage 340 in correspondence to the changed mode along with the image data, thereby facilitating grasp of conditions of the vehicle, which are grounds for the change of the mode of the controller 400.

The image data and the detection information acquired through the image processor 310 and the sensing unit 350 are processed by the controller 400 and then may be visually displayed on a display unit 390, thereby allowing a user to grasp proximity of an external object and avoid the external object easily or visually confirm vehicle driving and condition-related information.

In addition, the controller 400 may be connected to a communication unit 380 for communication with external modules to which the acquired image data or detection information are transferred or from which external information is acquired. Accordingly, if there occurs an emergency such as collision with an external object, it is possible to receive a prompt action by transferring the image data and the detection information to the outside. In addition, it is possible to provide various extensibilities such as mobile communication, Internet, navigation, DMB (Digital Multimedia Broadcasting) receiving functions and so on through the communication unit 380.

Furthermore, the black box device may include an interface 370, having one or more buttons for input from a user, through which the user can set operation environments such as a reference value of the degree of proximity of an external object, a detection period, the number of image data frames, a resolution, a recording period and so on in a direct manner or a temporarily manual manner.

Since it is essential for the black box device to acquire image data related to an emergency situation such as collision with an external object, it is important that the black box device should preserve the image data soundly even in the emergency.

The essential condition for achieving the above purpose is to preserve the image data before and after occurrence of emergency. To this end, power of the black box device should be even temporarily supplied at emergency to maintain an operation to store the image data in a safe location and means storing the image data should be conserved. The solution to this will be described in detail with reference to FIG. 5.

FIG. 5 is a view showing a detailed configuration of a power source unit according to an embodiment of the invention. Referring to FIG. 5, when main power is supplied from the outside, this main power is supplied to various components through a power processor 321 included in the power source unit 320. At this time, the power source unit 320 may include a supplementary power supply 322 to supply emergency power to various components if the supply of the main power is interrupted due to an emergency. Examples of the supplementary power supply 322 may include a chargeable battery, an independent power source, a chargeable passive element, etc. which can be charged by the main power.

If the supply of the main power is interrupted due to an external impact, since the amount of power to be supplied by the supplementary power supply is limited, the power of the supplementary power supply is required to be efficiently distributed to only devices indispensable for preserving the image data and the vehicle-related information. For example, it is necessary that the power of the supplementary power supply should be supplied to the virtual memory for temporarily storing the image data, the detachable memory unit for safely preserving the image data and the vehicle-related information against an external impact, and the controller for collecting the image data stored in the virtual memory and the vehicle-related information from the sensors and transferring the collected data and information to the detachable memory unit.

Accordingly, the components included in the black box device may be classified into a first device group 510 directly connected to the power processor and a second device group 520 supplied with power indirectly through control of the controller.

In this case, since the controller and the first device group 510 are components essential to preserve the image data and the vehicle-related information, these components should be continuously supplied with power even at emergency. On the other hand, supply of power to the second device group 520, which includes components except the first device group 510, can be interrupted by the controller at emergency. In addition, the first device group 510 preferably includes the virtual memory and the detachable memory unit, and additionally the camera and the image processor for grasp of situations after the emergency.

As described above, by supplying power to only the components essential to preserve the image data and the vehicle-related information, it is possible to preserve the image data and the vehicle-related information even with limited supply of power of the supplementary power supply even when the main power is interrupted. In addition, since it is important to grasp situations immediately before occurrence of emergency even if even the supplementary power supply lacks power due to any discharging, as long as the minimum amount of current required to transfer the image data from the virtual memory to the detachable memory unit remains in an internal circuit, it is possible to transfer the image data to the detachable memory unit for safe preservation of the image data.

Hereinafter, a process in which the black box device preserves the image data will be described in detail.

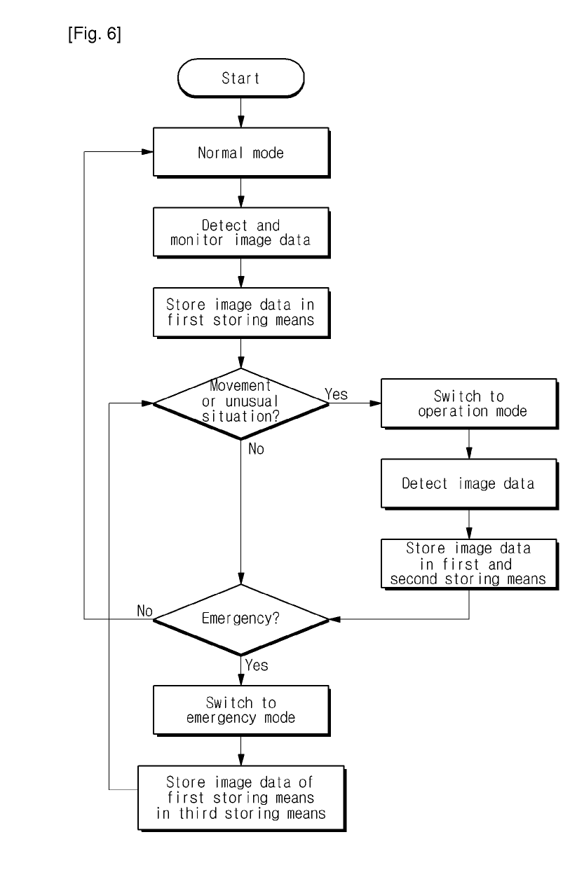

FIG. 6 is a flow chart illustrating a process of preserving image data according to an embodiment of the invention. It is assumed in the following process that the black box device can select a mode according to the above-described situations and take a proper action according to the selected mode.

First, the black box device operates with the normal mode in stop of the vehicle, collects the image data detected by the camera installed in the vehicle and detects the surroundings of the vehicle through one or more sensors installed in the internal and external of the vehicle. Since there is a relatively low possibility of occurrence of emergency in the stop of vehicle, the image data and the detected information are accumulatively stored in first storing means at specified time intervals. At this time, old information may be replaced with new information.

If an emergency such as proximity of an external object is detected based on the detection information of the sensors in operation in the normal mode, the black box device is switched to an emergency mode, and in the emergency mode, the image data stored in the first storing means are stored in third detachable storing means having low risk of damage for preservation of the image data.

In addition, if movement of the vehicle is detected based on the detection information of the sensors during the operation in the normal mode, the black box device is switched from the normal mode to an operation mode, and driving-related information can be recorded in real time in separate nonvolatile mass second storing means as well as the first storing means. At this time, if there occur unusual situations such as intrusion of an unauthorized person into the vehicle or breaking out of fire in the vehicle, it is to be understood that the black box device can be switched to the operation mode and record information on the unusual situations in the second storing means in real time.

If the emergency occurs during the operation in the operation, the black box device is switched to the emergency mode based on the detection information of the sensors or by setting by a user, and stores the image data stored in the first storing means in the third storing means for preservation of the image data.

In addition, even if the main power is interrupted in switching to the emergency mode in occurrence of emergency, the black box device uses the supplementary power supply to transfer the image data to the third storing means for safe preservation of the image data.

In addition, when the image data are compressed to reduce the amount of data and stored in the first storing means in the normal mode and the operation mode, it is possible to transfer the image data to the third storing means with less amount of current even at emergency. Moreover, when the number of frames of the image data is less recorded in the first storing means than in the second storing means, it is possible to store more situation information in the third storing means at emergency. Of course, these methods may be mixed according to circumstances.

1. An image processing apparatus comprising:
an image processing unit that processes image data detected by one or more cameras installed in a vehicle;
a sensing unit that includes one or more sensors for detecting surroundings of the vehicle;
a power source unit that receives power from the vehicle and supplies the power to other components of the vehicle;
a virtual memory unit that temporarily stores the image data;
a storing unit that stores the image data;
a detachable memory unit that backs up the image data at emergency; and
a controller that stores the image data from the image processing unit in the storing unit in stop or normal driving of the vehicle based on detection information from the sensing unit, and stores the image data of the virtual memory unit in the detachable memory unit at the emergency,
wherein the controller interrupts supply of power to various components at the emergency, except the virtual memory unit, the detachable memory unit and the controller itself, based on the detection information from the sensing unit.

2. The image processing apparatus according to claim 1, wherein the sensing unit detects collision of the vehicle with an external object, movement of the vehicle and interruption of supply of power.

3. The image processing apparatus according to claim 2, wherein the sensing unit further collects information on driving and conditions of the vehicle.

4. The image processing apparatus according to claim 3, wherein the controller stores vehicle-related information including the condition information on the vehicle in the detachable memory unit at the emergency based on the detection information from the sensing unit.

5. The image processing apparatus according to claim 1, wherein the power source unit further includes a supplementary power supply for supplying supplementary power if the power supplied from the vehicle is interrupted.

6. The image processing apparatus according to claim 1, wherein the controller maintains supply of power to the cameras, the image processing unit, the virtual memory unit, the detachable memory unit and the controller itself at the emergency based on the detection information from the sensing unit.

7. The image processing apparatus according to claim 1, wherein the storing unit comprises a hard disk or a nonvolatile memory.

8. The image processing apparatus according to claim 1, wherein the detachable memory unit comprises a detachable memory card.

9. The image processing apparatus according to claim 1, further comprising a communication unit which is connected to the controller for communication with external modules, wherein the controller outputs the detection information and the image data through the communication unit.

10. The image processing apparatus according to claim 1, further comprising an interface that is connected to the controller for receiving input from a user, wherein the controller switches between its operation conditions according to the input from the user through the interface.

11. The image processing apparatus according to claim 2, wherein the controller stores vehicle-related information including the condition information on the vehicle in the detachable memory unit at the emergency based on the detection information from the sensing unit.
